(19) United States
(12) Patent Application Publication
(10) Pub. No.: US 2004/0228023 A1
(43) Pub. Date: Nov. 18, 2004

(54) Method and apparatus for heating a disk drive

(76) Inventors: Lee A. Keller, Winnebago, IL (US); Itamar David, Buffalo Grove, IL (US)

Correspondence Address: MOTOROLA, INC., 1303 EAST ALGONQUIN ROAD, IL01/3RD, SCHAUMBURG, IL, 60196

(21) Appl. No.: 10/436,297

(22) Filed: May 12, 2003

(51) Int. Cl. G11B 19/02; G11B 27/36

(52) U.S. Cl. 360/69; 360/31

(57) ABSTRACT

A method and apparatus for controlling the temperature of a disk drive, wherein: a sensor element measures the temperature of a disk drive; a heating element heats the disk drive; and a logic device coupled to the sensor element and the heating element monitors the temperature measured by the sensor element and controls the heating element to cause the heating element to heat the disk drive when the temperature is lower than a predetermined temperature threshold.

### FIELD OF THE INVENTION

The present invention relates generally to a method and apparatus for heating a disk drive that is included, for instance, in a ruggedized laptop computer.

### BACKGROUND OF THE INVENTION

Mechanical hard disk drives (also referred to herein as disk drives and hard disk drives) are devices used to read stored data on a storage media (e.g., magnetic or optical disk) and to write data onto the storage media. Disk drives are commonly used in many computing devices such as personal laptop computers. Typically these disk drives have a limited operating temperature specification of about +5C to +55C, meaning that the disk drive is designed to function properly in ambient temperatures that fall within the range of the operating temperature specification. However, in the mobile environment it is not uncommon for a user of a personal computing device to have a need for operating the computing device under temperature extremes that fall outside of the hard disk drive's operating specification. For instance, mobile professionals such as public safety officers often use their vehicles as mobile offices, thereby creating the need for having mobile computing equipment installed within the vehicle. While housed in the vehicle, this equipment might routinely be exposed to temperature extremes. This is especially true if the equipment is left in an unattended vehicle or in a vehicle trunk and the temperature therein is left uncontrolled.

Operating a computing device under temperature conditions that cause the disk drive to operate outside of its intended operating specifications may cause the disk drive to experience one or more of a number of problems. For instance, the disk drive may experience a loss of data, poor reliability, a decreased life expectancy, or damage. In the most extreme case, the disk drive may suffer a complete mechanical failure.

One alternative known in the art for extending the operating range of a computing device's hard disk drive, thereby enabling the disk drive to function in extreme temperature conditions, is the use of a solid state disk drive. Solid state disk drives are available with enhanced or extended temperature ranges as low as −40C. However, a solid state disk drive has two major limitations. First, it is relatively expensive, and second, it has a limited storage capacity when compared to a mechanical hard disk drive.

Thus, there exists a need for a method and apparatus for controlling the temperature of a disk drive so that the disk drive can be safely operated when the ambient temperature exceeds the normal temperature operating range of the disk drive.

### BRIEF DESCRIPTION OF THE DRAWINGS

A preferred embodiment of the invention is now described, by way of example only, with reference to the accompanying figures in which:

FIG. 1 illustrates a circuit diagram of disk drive heating apparatus in accordance with a preferred embodiment of the present invention;

FIG. 2 illustrates a flow diagram of a method for controlling the temperature of a disk drive in accordance with an embodiment of the present invention;

FIG. 3 illustrates an implementation of the heater flex illustrated in the circuit diagram of FIG. 1; and

FIG. 4 illustrates the heater flex implementation of FIG. 3 attached to a disk drive.

### DETAILED DESCRIPTION OF THE PREFERRED EMBODIMENT

While this invention is susceptible of embodiments in many different forms, there are shown in the figures and will herein be described in detail specific embodiments, with the understanding that the present disclosure is to be considered as an example of the principles of the invention and not intended to limit the invention to the specific embodiments shown and described. Further, the terms and words used herein are not to be considered limiting, but rather merely descriptive. It will also be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate corresponding elements.

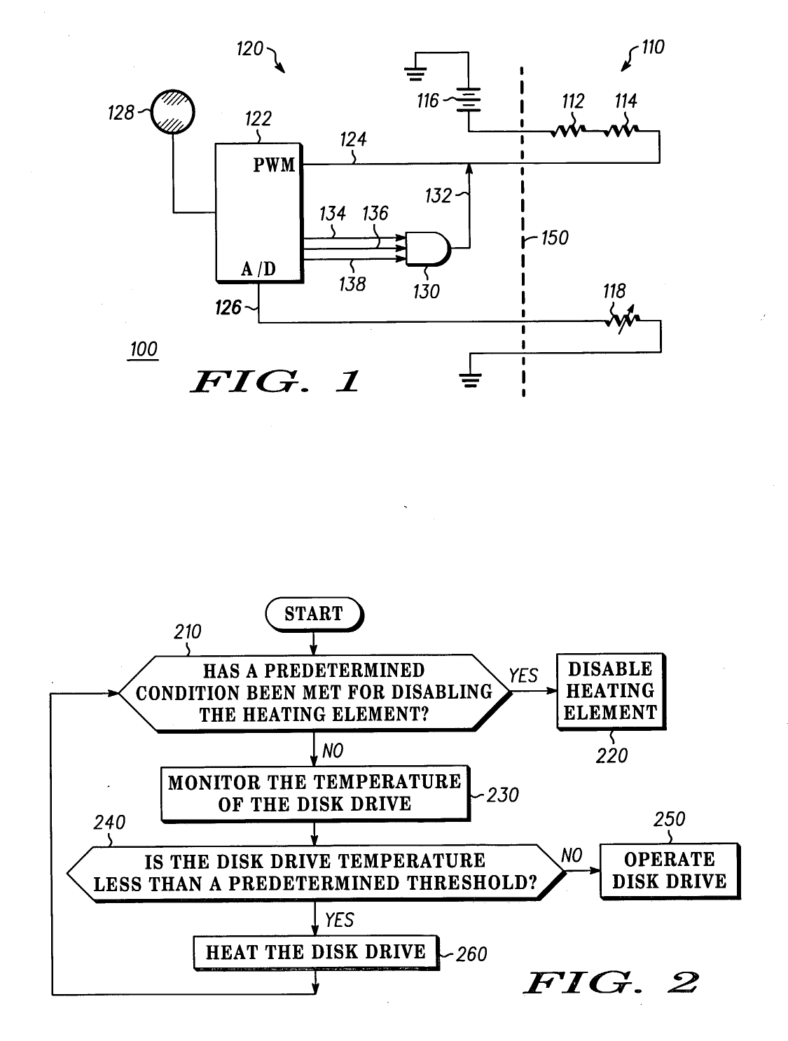

FIG. 1 illustrates a circuit diagram of a disk drive heating apparatus 100 in accordance with the present invention. Apparatus 100 may be used to control the temperature of a disk drive so that the disk drive may be safely operated when the ambient temperature exceeds the normal temperature operating range of the disk drive.

Apparatus 100 includes a heating device 110, also referred to herein as a “heater flex”. The heater flex 110 includes a heating element that preferably comprises two resistive heating elements 112 and 114 (also referred to herein as resistive elements and also known in the industry as “thermal foils”) that are used to heat the hard disk drive, for instance, when its temperature falls below a predetermined temperature threshold. Resistive elements 112 and 114 are preferably coupled in series to a power supply 116. The resistance values are determined as a function of the available input voltage 116 to the heating device and will vary based on the available voltage level. It is further desirable to select the resistance values for resistive elements 112 and 114 to prevent damage to the heater flex 110 when it is operating at maximum heating levels. For example, where power supply 116 is generated by a vehicle battery, resistance values may be set at 35Ω for each of the resistive elements 112 and 114 to efficiently heat a computing device's disk drive and maintain the temperature of the disk drive at about +5C when the ambient temperature is about −20C, while simultaneously preventing damage to the heater flex.

As indicated above, the preferred embodiment of heater flex 110 includes a heating element that comprises two resistive elements in a series configuration. Such a configuration allows heat to be applied to strategic locations on the disk drive for optimal heating of the disk drive. However, those of ordinary skill in the art will realize that the present invention can be implemented, for instance, using one resistive element that covers the entire surface of the disk drive or a large portion thereof.

The heater flex 110 further comprises a temperature sensor element 118 coupled to ground. Sensor element 118 is used to detect and accurately measure the temperature of the disk drive. Sensor element 118 can be any device capable of accurately measuring the surface temperature of the disk drive. Preferably sensor element 118 is a variable resistive element such as the ABM1020 temperature sensor by Analog Devices.

Referring again to power supply 116, in an embodiment of the present invention apparatus 100 is included in a personal computing device such as ruggedized laptop that is specifically designed to operate in harsh and severe environmental conditions. In this embodiment, power supply 116 is preferably generated by a vehicle battery, which can be accomplished in any conventional manner such as by coupling the laptop to a docking station located inside of the vehicle. This configuration enables the heater flex 110 to leverage off of the higher capacity vehicle battery supply to sustain its operation. Those of ordinary skill in the art will realize that a battery that is located internal to the computing device may also be used to generate power supply 116.

Heating apparatus 100 further comprises components 120 that include a logic device 122 for controlling the heating element and, preferably, a device 130 for disabling the heating element when at least one of several predetermined conditions is met. Although device 130 is shown as a separate element for illustrative purposes, this device is preferable integrated within logic device 122. Components 120 are preferably included on the main circuit board of the personal computing device but may alternatively be located on a separate control or “daughter” circuit board. In either case, components 120 are configured for providing a controller interface 150 to the heater flex and temperature feedback from the heater flex to the controller.

Logic device 122 is preferably a microprocessor or micro-controller, such as the H8-34379 manufactured by Hitachi™, which can ideally be programmed to perform algorithms to control the operating characteristics and performance of the apparatus 100. Use of a micro-controller is advantageous in that it enables many of the operational characteristics of apparatus 100 to be software defined as explained in more detail below, thereby resulting in apparatus 100 having flexible and customizable operating characteristics. Micro-processor 122 preferably outputs a pulse width modulated (PWM) signal 124 to control the amount of heat generated by resistive elements 112 and 114. PWM control of the resistive elements enables the level of heat generated by these resistive elements to be software defined and easily adjusted.

Although the preferred embodiment implements a PWM control signal 124, those of ordinary skill in the art will realize that the type of control signal may be varied according to the particular components used to implement the present invention. For instance, a linear control signal may be used to provide for a fixed heating level by the heater flex. Such a configuration may be implemented in the hardware of apparatus 100.

Micro-controller 122 is further preferably configured to support an increased heating rate if a power button 128 to the computing device is depressed, thereby signaling a desire to use the computing device. Micro-controller 122 may also be used to customize or adapt the heating capabilities of the heater based on specific environments or on user requirements.

Micro-controller 122 is coupled to sensor 118 at an input 126 for monitoring the temperature measured by this sensor. Since sensor 118 generates an analog signal, it is coupled to an analog-to-digital converter input 126 of micro-controller 122.

Micro-controller 122 is further preferably configured to monitor, through any conventional means, one or more parameters that will determine whether the resistive elements 112 and 114 should be disabled. These parameters may include, but are not limited to, the vehicle battery level, the computing device battery level, and the state of a timer. In this way micro-controller 122 may signal device 130, through inputs 134, 136 and 138, to disable the resistive elements 112 and 114 when at least one predetermined condition is met. For instance, micro-controller 122 may signal device 130 to disable the heating element when: (1) a timer has timed out (e.g., a timer controlling the maximum ON time of the resistive elements 112 and 114 when the computing device is not used or is in an OFF state); (2) the temperature of the hard drive is within a predetermined temperature range or above a predetermined temperature threshold; and (3) the power supply level is above a predetermined level. Element 130 would, in turn, disable the heating element through its output 232. In addition, preferably apparatus 100 further comprises a voltage level sensing device (not shown) that accurately senses the vehicle voltage level. In the preferred embodiment, the sensing device is located on a vehicle docking station, which interfaces to the micro-controller of the computing device.

As stated above, use of a micro-controller is advantageous in that it enables many of the operational characteristics of the heating apparatus to be software defined. For instance, the following operational characteristics of heating apparatus 100 are ideally software definable: an adjustable timer for heating apparatus run time; a maximum ON time of the heating element while the computing device is not in use; a battery voltage threshold below which the heating element will not work; determination of the power supply source in use; the heating element disabling function; and profiles for connecting to an external power source (e.g., a vehicle battery) or an internal power source (e.g., the computing device battery). Those of ordinary skill in the art will realize that the above list of operating characteristics that may be software definable and controlled by a micro-controller is not intended to limit the scope of the present invention and is not an exhaustive list of such operating characteristics.

FIG. 2 illustrates a flow diagram of a method in accordance with the present invention for controlling the temperature of a disk drive. At step 210 it is preferably determined, by the micro-controller in the FIG. 1 embodiment of the invention, whether a predetermined condition has been met for disabling the heating element. As discussed above, the predetermined conditions may include, but are not limited to, a timer having timed out, the power supply being inadequate, and the temperature of the disk drive being within its temperature operating specifications. If one of the predetermined conditions is met, then at step 220, the heating element is disabled. If no condition exists for disabling the heating element, at step 230 the temperature of the disk drive is monitored, again in this example by the micro-controller, which also determines at step 240 whether the disk drive temperature is within a predetermined temperature range, e.g., whether the temperature is less than the lower threshold of the temperature operating specifications of the disk drive. If the disk drive temperature is within its operating specification, then the disk drive may be safely operated at step 250. However, if the disk drive temperature is outside of its temperature operating specification then the disk drive is heated and the process flow returns to step 310.

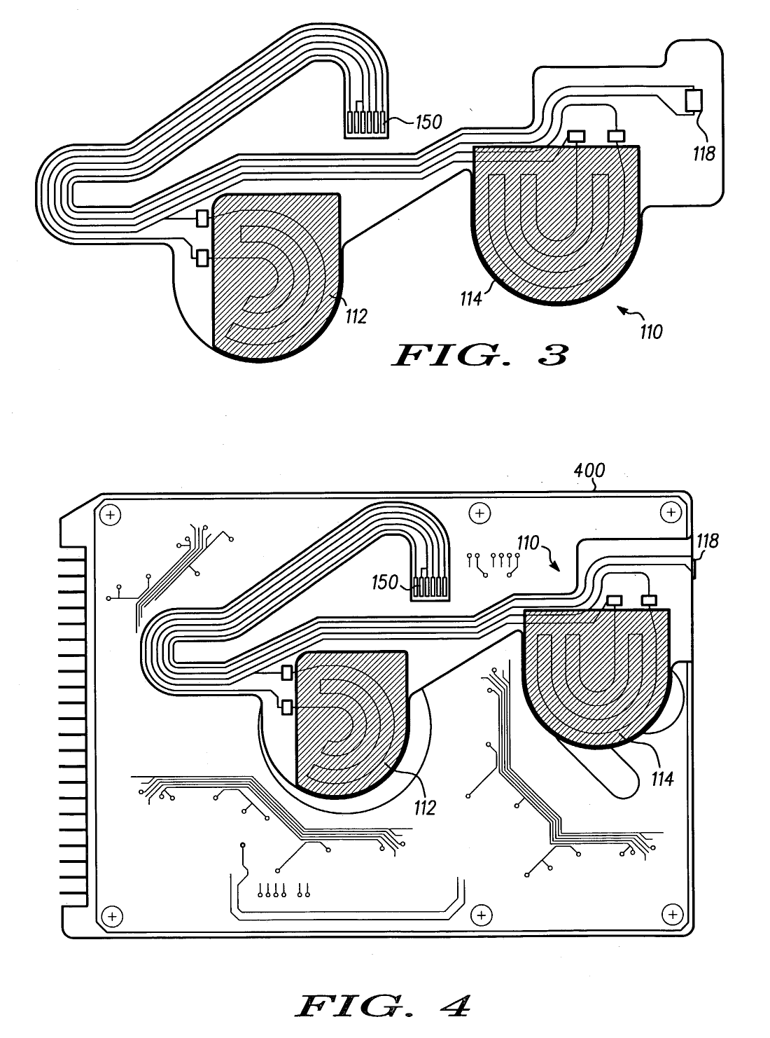

FIG. 3 illustrates an implementation of the heater flex 110 shown in the circuit diagram of FIG. 1. In this embodiment, heater flex 110 is implemented as a Flexible Printed Circuit (FPC) having resistive elements 112 and 114 and temperature sensor element 118. Interface 150 is implemented as a set of connectors.

FIG. 4 illustrates the heater flex implementation of FIG. 3 attached to a disk drive 400. Heater flex 110 is preferably attached directly to the disk drive 400 with adhesive. It can also be seen in FIG. 4 the strategic placement of resistive elements 112 and 114 for optimal heating of the disk drive. In addition, temperature sensor element 118 is shown overlapping the side of disk drive 400. In another embodiment, sensor 118 may be located on top of the disk drive with the resistive elements to minimize damage to the sensor element.

In the preferred embodiment illustrated in FIG. 4, the heater flex is directly attached to the disk drive. However, those of ordinary skill in the art will realize that the present invention can be implemented with the heater flex attached to an appropriate housing structure that is attached to the disk drive in some conventional way, for instance, wherein the housing structure completely surrounds the disk drive. Moreover, the heater flex may be configured such that it is integrated into the internal circuitry of the disk drive.

Disk drive 400 may be included in any number of computing devices such as a desktop personal computing device, or a laptop personal computing device. In a preferred embodiment, disk drive 400, which includes heating apparatus in accordance with the present invention, is included in a ruggedized laptop computing device that is specifically designed to operate in harsh and severe environmental conditions. However, those of ordinary skill in the art will realize that this in no way limits the applicability of the present invention to other types of computing devices.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

What is claimed is:

1. Apparatus for controlling the temperature of a disk drive comprising:
a sensor element for measuring the temperature of a disk drive;
a heating element for heating said disk drive; and
a logic device coupled to said sensor element and said heating element for monitoring the temperature measured by said sensor element and for controlling said heating element to cause said heating element to heat said disk drive when said temperature is lower than a predetermined temperature threshold.

2. The apparatus of claim 1, wherein said heating element comprises at least one resistive element.

3. The apparatus of claim 1, wherein said logic device is a microprocessor that performs an algorithm for monitoring said temperature and for controlling said heating element.

4. The apparatus of claim 1, wherein said logic device generates a pulse width modulation signal for controlling said heating element.

5. The apparatus of claim 1, wherein said logic device generates a linear signal for controlling said heating element.

6. The apparatus of claim 1, wherein said sensor element includes a variable resistive element.

7. The apparatus of claim 1, wherein a power source, which is external to a computing device that includes said apparatus, provides a power supply for said heating element.

8. The apparatus of claim 7, wherein said power source is a vehicle battery.

9. The apparatus of claim 1, wherein a power source, which is internal to a computing device that includes said apparatus, provides a power supply for said heating element.

10. The apparatus of claim 1 further comprising a device under the control of said logic device for disabling said heating element when a predetermined condition is met.

11. The apparatus of claim 10 further comprising a timer, and wherein said predetermined condition is said timer having timing out.

12. The apparatus of claim 10, wherein said predetermined condition is an inadequate power level having been supplied to said heating element.

13. A method for use in apparatus for controlling the temperature of a disk drive, comprising the steps of:
monitoring the temperature of a disk drive;
determining whether the temperature is within a predetermined temperature range; and
causing the temperature of said disk drive to be adjusted when it is determined that the temperature is outside of said predetermined temperature range.

14. The method of claim 13, wherein the temperature is monitored to determine whether it is lower that a predetermined threshold, and wherein said disk drive is heated when it is determined that the temperature is lower than said predetermined threshold.

15. The method of claim 13, wherein said apparatus includes a heating element for heating said disk drive, and said method further comprises the step of disabling said heating element when a predetermined condition is met.

16. The method of claim 15, wherein said predetermined condition is a timer having timing out.

17. The method of claim 15, wherein said predetermined condition is an inadequate power level having been supplied to said heating element.

18. The method of claim 17, wherein the power supply for said heating element is a battery voltage, and wherein said heating element is disabled when said battery voltage falls below a predetermined voltage threshold.

19. The method of claim 13, wherein the temperature of said disk drive is adjusted under the control of a pulse width modulation signal.

20. The method of claim 13, wherein the temperature of said disk drive is adjusted under the control of a linear signal.

21. A method for use in apparatus for controlling the temperature of a disk drive, comprising the steps of:
monitoring the temperature of a disk drive;
determining whether the temperature is lower then a predetermined temperature threshold; and
causing the temperature of said disk drive to be increased when it is determined that the temperature is lower than said predetermined temperature threshold.
